(19) United States
(12) Patent Application Publication
(10) Pub. No.: US 2025/0261077 A1
(43) Pub. Date: Aug. 14, 2025

(54) METHOD AND APPARATUS FOR PROVIDING MOBILITY CONFIGURATION IN A WIRELESS COMMUNICATION SYSTEM

(71) Applicant: Samsung Electronics Co., Ltd., Suwon-si (KR)

(72) Inventor: Aby Kanneath ABRAHAM, Bangalore (IN)

(21) Appl. No.: 19/049,505

(22) Filed: Feb. 10, 2025

(30) Foreign Application Priority Data
Feb. 8, 2024 (IN) 202441008560
Jan. 23, 2025 (IN) 2024 41008560

(51) Int. Cl. H04W 36/36; H04W 12/04; H04W 36/00

(52) U.S. Cl. CPC H04W 36/362; H04W 12/04; H04W 36/0038

(57) ABSTRACT

A method for performing for handover while maintaining a Subsequent Conditional primary serving Cell (PS Cell) Addition or Change (SCPAC) configuration in communication system is provided. The method includes receiving, by target master node (MN), a handover request message from a source master node (MN) for performing the handover, wherein handover request message includes SCPAC configuration, determining, by the target MN, to maintain the SCPAC configuration received in the handover request message, creating, by the target MN, a Radio Resource Control (RRC) reconfiguration message by including ReconfigurationwithSync and a conditional reconfiguration, wherein the target MN includes the conditional reconfiguration for maintaining the SCPAC configuration, and transmitting, by the target MN, a handover acknowledgement (HO ACK) message to the source MN, wherein the HO ACK message includes RRC reconfiguration message.

### CROSS-REFERENCE TO RELATED APPLICATION(S)

This application is based on and claims priority under 35 U.S.C. § 119(a) of an Indian Provisional patent application No. 20/244,1008560, filed on Feb. 8, 2024, in the Indian Intellectual Property Office, and of an Indian Non-Provisional patent application Ser. No. 20/244,1008560, filed on Jan. 23, 2025, in the Indian Intellectual Property Office, the disclosure of each of which is incorporated by reference herein in its entirety.

### BACKGROUND

### 1. Technical Field

The disclosure relates to a method for performing handover while maintaining Subsequent Conditional PS Cell Addition or Change (SCPAC) configuration in communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

In wireless technologies like Fifth Generation (5G) New Radio (NR), devices can move across different cells. Mobility is performed using a procedure called cell reselection in Radio Resource Control (RRC)-IDLE mode. Till NR R17, mobility is performed using a procedure called handover in RRC-CONNECTED mode. Network-controlled mobility applies to UEs in RRC-CONNECTED. It requires explicit RRC signaling to be triggered by the Radio Access Network (RAN node) node such as gNodeB (gNB) in NR. Handover in NR usually consists of three steps handover preparation, handover execution, and handover completion. The gNB may configure the User Equipment (UE) to report measurements, and based on the reported measurements or its own understanding of the network topology, the gNB will send an RRC Reconfiguration message to handover the UE to another cell called the target cell from the source cell. RRC Reconfiguration message to handover is typically generated by target RAN node. Source RAN node may send a Handover Request and the target RAN node responds with Handover Acknowledgement including the RRC Reconfiguration message for performing handover. Source RAN node will send the RRC Reconfiguration message from the target to the UE in its own RRC Reconfiguration message. UE accesses the target cell and sends an RRC Reconfiguration complete message. In an alternative way introduced in 3rd Generation Partnership Project (3GPP) NR release 16, the gNB may configure the UE with the execution conditions for triggering handover, and once the execution conditions are satisfied, the UE may move to the target cell and send the RRC Reconfiguration complete. 3GPP also introduced a new handover called DAPS handover in release 16. In all these methods, UE performs handover by sending layer 3 (RRC) messages, which causes considerable signaling overhead and latency issues. We can refer to the handover and conditional handover (CHO) as layer 3 mobility. In the case of dual connectivity, UE may perform PSCellChange or Conditional PSCellChange. In the context of dual connectivity, we can refer to PSCellChange or Conditional PSCellChange also as layer 3 mobility, i.e., Handover, Conditional Handover, PSCellChange, Conditional PSCellChange, etc., refers to L3 mobility. Dual connectivity includes a master node (MN) and a secondary node (SN). UE will be configured with two cell groups, a Master Cell Group (MCG) and a Secondary Cell Group (SCG). We can also refer to PSCellChange or Conditional PSCellChange as SCG layer 3 mobility and the handover and CHO as MCG layer 3 mobility in the context of dual connectivity. UE releases the conditional configuration after executing conditional handover or conditional primary secondary cell (PSCell) Addition or conditional PSCellChange. 3gpp Release 18 introduced Subsequent Conditional PSCell Addition or Change (SCPAC) where the UE does not release the conditional reconfiguration after executing the PSCell Addition or PSCell Change. UE perform subsequent Conditional PS Cell Addition or Change (CPAC) using a set of SCG associated counters related to security operations known as sk-counters. Determination of sk-counters involve MN also, as MN has overall responsibility of maintaining security at the UE. MN may send a masterkeyupdate to update the security parameters such as the master key used for overall security operations.

3GPP release 18 is considering lower-layer triggered mobility (LTM) to solve the problem related to latency, signaling overhead, and the like associated with layer 3 mobility. As per 3GPP, the goal of the LTM is to enable a serving cell change via L1/L2 signaling in order to reduce the latency, overhead, and interruption time. The network (gNB) may configure the UE with multiple candidate cells to allow fast application of configurations for candidate cells. The network can further send MAC CE or L1 signaling to dynamically switch the UE from a source cell to one of the configured candidate cells. Further, LTM can be triggered based on L1 measurements rather than L3 measurements.

During primary cell (PCell) handover, MN can either release subsequent CPAC configuration or maintain subsequent CPAC configuration. However, the conventional technique does not allow the MN to include conditionalReconfiguration in the RRC Reconfiguration message send for the PCell handover.

Also, in 3GPP, upon PCell handover, the MN will generate a new set of counter values (sk-counter configuration) to be used by SN and the UEs, and this needs to be provided. However, the conventional technique prevents the MN from providing the new sk-counter configuration to the UE at the time of PCell handover.

For the purpose of the proposed disclosure, 3GPP specifications such as TS 38.300, TS 38.331, TS 38.321 V1800 are considered as relevant background.

Thus, it is desired to address the above-mentioned disadvantages, issues, or other shortcomings, or at least provide a useful alternative.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method for configuring LTM and subsequent CPAC in NR.

Another aspect of the disclosure is to prepare a handover while maintaining SCPAC configuration in a communication system.

Another aspect of the disclosure is to configure security keys for subsequent CPAC.

Another aspect of the disclosure is to generate measurement gaps for LTM by DU.

Another aspect of the disclosure is to handle the request to transfer the RRC message after the LTM cell switch is triggered.

Additional aspects will be set forth in part in the description which follows and, in part, will be apparent from the description, or may be learned by practice of the presented embodiments.

In accordance with an aspect of the disclosure, a method performed by a terminal in a communication system is provided, the method comprising: receiving, from a base station, a message comprising information on a conditional reconfiguration; and performing at least one of an addition, a modification, or a removal for a list of a security key (sk) counter, wherein, in case that the message comprises information on a reconfiguration with sync, the information on the conditional reconfiguration comprises information on a sk-counter configuration.

In accordance with an aspect of the disclosure, wherein, the message comprises information on a master cell group, and wherein, in case that the information on a master cell group comprises the information on the reconfiguration with sync, the information on the conditional reconfiguration comprises configurations associated with a subsequent conditional primary secondary cell (PSCell) addition or change (CPAC).

In accordance with an aspect of the disclosure, wherein the information on the sk-counter configuration comprises the list of sk-counter.

In accordance with an aspect of the disclosure, wherein the message comprises a radio resource control (RRC) reconfiguration message.

In accordance with an aspect of the disclosure, a method performed by a base station in a communication system is provided, the method comprising: identifying that a message comprises information on a reconfiguration with sync; and transmitting, to a terminal, the message comprising information on a conditional reconfiguration, wherein, in case that the message comprises the information on the reconfiguration with sync, the information on the conditional reconfiguration comprises information on a security key (sk) counter configuration, and wherein a list of an sk counter is performed at least one of an addition, a modification, or a removal by the terminal.

In accordance with an aspect of the disclosure, a terminal in a communication system is provided, the terminal comprising: a transceiver; and at least one processor coupled with the transceiver and configured to: receive, from a base station, a message comprising information on a conditional reconfiguration, and perform at least one of an addition, a modification, or a removal for a list of a security key (sk) counter, wherein, in case that the message comprises information on a reconfiguration with sync, the information on the conditional reconfiguration comprises information on a sk-counter configuration.

In accordance with an aspect of the disclosure, a base station in a communication system is provided, the base station comprising: a transceiver; and at least one processor coupled with the transceiver and configured to: identify that a message comprises information on a reconfiguration with sync, and transmit, to a terminal, the message comprising information on a conditional reconfiguration, wherein, in case that the message comprises the information on the reconfiguration with sync, the information on the conditional reconfiguration comprises information on a security key (sk) counter configuration, and wherein a list of an sk counter is performed at least one of an addition, a modification, or a removal by the terminal.

In accordance with an aspect of the disclosure, a method for performing SCPAC configuration in a communication system is provided. The method includes receiving, by a target master node (MN), a handover request message from a source master node (MN) for performing the handover, wherein the handover request message comprises the SCPAC configuration, determining, by the target MN, to maintain the SCPAC configuration received in the handover request message, creating, by the target MN, an RRC reconfiguration message by including a ReconfigurationwithSync and a conditional reconfiguration, wherein the target MN includes the conditional reconfiguration for maintaining the SCPAC configuration during the handover, and transmitting, by the target MN, the handover acknowledgement (HO ACK) message to the source MN wherein the HO ACK message comprises the RRC reconfiguration message.

In an embodiment, the method includes adding by the target MN an sk-counter configuration in the conditional reconfiguration wherein the sk-counter configuration comprises an sk-counter list.

In an embodiment, the RRC reconfiguration message includes a masterkeyupdate.

In accordance with another aspect of the disclosure, a method for performing SCPAC configuration in a communication system is provided. The method includes receiving, by a UE, an RRC reconfiguration message from the source MN to perform handover, wherein the RRC reconfiguration message includes the ReconfigurationwithSync and the conditional reconfiguration, and performing, by the UE, a handover based on the ReconfigurationwithSync and the conditional reconfiguration.

In accordance with another aspect of the disclosure, a method for performing SCPAC configuration in a communication system is provided. The method includes transmitting, by the source MN, a handover request message to the target MN for performing the handover wherein the handover request message includes the SCPAC configuration, receiving, by the source MN, a handover acknowledgement message from the target MN, wherein the HO ACK message includes the RRC reconfiguration message, and transmitting, by the source MN, the RRC reconfiguration message to the UE to perform the handover from the source MN to the target MN, wherein the RRC reconfiguration message includes the ReconfigurationwithSync and the conditional reconfiguration.

In accordance with another aspect of the disclosure, a target MN performing a handover while maintaining SCPAC in a communication system is provided. The target MN includes a processor and a conditional handover controller communicatively coupled to the processor, wherein the conditional handover controller is configured to receive the handover request message from the source MN for performing the handover, wherein handover request message includes the SCPAC configuration, determine to maintain the SCPAC configuration received in the handover request message, create the RRC reconfiguration message by including the ReconfigurationwithSync and the conditional reconfiguration, wherein target MN includes the conditional reconfiguration for maintaining the SCPAC configuration during the handover, and transmit a HO ACK message to the source MN, wherein the HO ACK message includes the RRC reconfiguration message (such as NR RRCReconfiguration message).

In accordance with another aspect of the disclosure, a UE for performing the handover while maintaining SCPAC configuration in the communication system is provided. The UE includes a processor and a conditional handover controller coupled with the processor, wherein the conditional handover controller is configured to receive a RRC reconfiguration message from the source MN to perform handover, wherein the RRC reconfiguration message includes the ReconfigurationwithSync and the conditional reconfiguration, and perform a handover based on the ReconfigurationwithSync and the conditional reconfiguration.

In accordance with another aspect of the disclosure, a source MN for performing a handover while maintaining SCPAC is provided. The source MN includes a processor and a conditional handover controller coupled with the processor, wherein the conditional handover controller is configured to transmit the handover request message to the target MN for performing the handover, wherein the handover request message includes the SCPAC configuration, receive a handover acknowledgement message from the target MN, wherein the HO ACK message includes the RRC reconfiguration message, and transmit the RRC reconfiguration message to the UE to perform the handover from the source MN to the target MN, wherein the RRC reconfiguration message includes the ReconfigurationwithSync and a conditional reconfiguration.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of a target master node for performing a handover while maintaining SCPAC configuration in a communication system according to an embodiment of the disclosure;

FIG. 2 is a block diagram of UE for performing a handover while maintaining SCPAC configuration in a communication system according to an embodiment of the disclosure;

FIG. 3 is a block diagram of a source master node for performing a handover while maintaining SCPAC configuration in a communication system according to an embodiment of the disclosure;

FIG. 4 is a flow diagram that illustrates a method for performing handover while maintaining SCPAC configuration in a communication system by a target master node according to an embodiment of the disclosure;

FIG. 5 is a flow diagram that illustrates a method for performing handover while maintaining SCPAC configuration in a communication system by UE according to an embodiment of the disclosure;

FIG. 6 is a flow diagram that illustrates a method for performing handover while maintaining SCPAC configuration in a communication system by a source master node according to an embodiment of the disclosure;

FIG. 7 is a sequence diagram that illustrates a sequence of performing handover while maintaining SCPAC configuration in a communication system according to an embodiment of the disclosure;

FIG. 8 is a sequence diagram that illustrates an LTM procedure according to an embodiment of the disclosure;

FIG. 9 is a flow diagram that illustrates distributed unit (DU) operations for LTM measurement gaps handling according to an embodiment of the disclosure; and

FIG. 10 is a flow diagram that illustrates DU operations for sending an RRC message to UE according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It may be noted that, to the extent possible, like reference numerals have been used to represent like elements in the drawing. Furthermore, those of ordinary skill in the art will appreciate that elements in the drawing are illustrated for simplicity and may not necessarily have been drawn to scale. For example, the dimensions of some of the elements in the drawing may be exaggerated relative to other elements to improve the understanding of aspects of the disclosure. Further, the elements may have been represented in the drawing by conventional symbols, and the drawings may show only those specific details that are pertinent to understanding the embodiments of the disclosure so as not to obscure the drawing with details that will be readily apparent to those of ordinary skill in the art having the benefit of the description herein.

As is traditional in the field, embodiments are described and illustrated in terms of blocks that carry out a described function or functions. These blocks, which are referred to herein as managers, units, modules, hardware components, or the like, are physically implemented by analog and/or digital circuits such as logic gates, integrated circuits, microprocessors, microcontrollers, memory circuits, passive electronic components, active electronic components, optical components, hardwired circuits, and the like, and may optionally be driven by firmware and software. The circuits, for example, may be embodied in one or more semiconductor chips or on substrate supports such as printed circuit boards and the like. The circuits constituting a block may be implemented by dedicated hardware or by a processor (e.g., one or more programmed microprocessors and associated circuitry) or by a combination of dedicated hardware to perform some functions of the block and a processor to perform other functions of the block. Each block of the embodiments may be physically separated into two or more interacting and discrete blocks without departing from the scope of the proposed method. Likewise, the blocks of the embodiments may be physically combined into more complex blocks without departing from the scope of the proposed method.

The accompanying drawings are used to help easily understand various technical features, and it is understood that the embodiments presented herein are not limited by the accompanying drawings. As such, the proposed method is construed to extend to any alterations, equivalents, and substitutes in addition to those which are particularly set out in the accompanying drawings. Although the terms “first,” “second,” etc. are used herein to describe various elements, these elements are not limited by these terms. These terms are generally used to distinguish one element from another.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

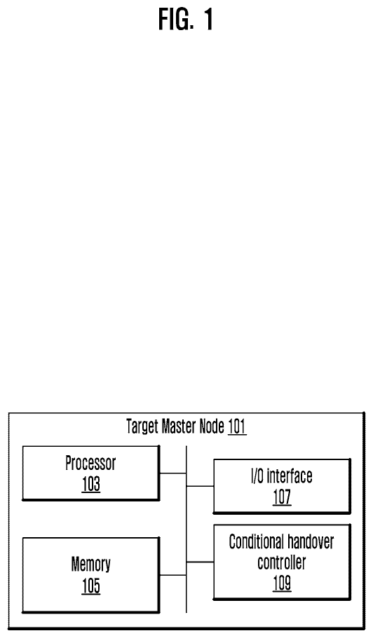

Referring now to the drawings, and more particularly to FIG. 1 through FIG. 10 where similar reference characters denote corresponding features consistently throughout the figures, there are shown preferred embodiments.

FIG. 1 is a block diagram of a target master node for performing a handover while maintaining SCPAC configuration in a communication system according to an embodiment of the disclosure. The target master node (101) is a network node that is an intended master node for the UE during the handover procedure or dual connectivity procedure. For example, the target master node (101) can be, but is not limited to, a gNodeB, eNodeB, a Sixth Generation (6G) Radio Access Node and base station. The target master node (101) includes a processor (103), memory (105), an input/output (I/O) interface (107), and a conditional handover controller (109). Furthermore, the processor (103) of the target master node (101) communicates with the memory (105), the I/O interface (107), and the conditional handover controller (109). The processor (103) is configured to execute instructions stored in the memory (105) and to perform various processes. The processor (103) can include one or a plurality of processors, can be a general-purpose processor such as a central processing unit (CPU), an application processor (AP), or the like, a graphics-only processing unit such as a graphics processing unit (GPU), a visual processing unit (VPU), and/or an Artificial Intelligence (AI) dedicated processor such as a neural processing unit (NPU).

Furthermore, the memory (105) of the target master node (101) includes storage locations that can be addressed through the processor (103). The memory (105) is not limited to volatile or non-volatile memory and can include one or more computer-readable storage media. Non-volatile storage elements such as magnetic hard disks, optical discs, floppy discs, flash memories, erasable programmable read only memory (EPROM), or electrically erasable programmable read only memory (EEPROM) memories can also be included in the memory (105). Further, the memory (105) of the target master node (101) can store various information received from UE and source master node. The target master node (101) can store several pieces of information such as SCPAC configuration and the like.

The I/O interface (107) transmits information between the memory (105) and external peripheral devices, which are input-output devices associated with the target master node (101). The I/O interface (107) receives various information from the UE and the source master node. This interface is used to maintain seamless communication between the target master node (101) and external devices, ensuring that data is transmitted and received. Additionally, the I/O interface (107) facilitates the integration of the target master node (101) with other network components, enhancing its capability for performing handover while maintaining the SCPAC configuration in the communication system.

The conditional handover controller (109) communicates with the I/O interface (107) and the memory (105) for performing a handover while maintaining the SCPAC configuration in the communication system. The conditional handover controller (109) is an innovative hardware that is realized through the physical implementation of both analog and digital circuits, including logic gates, integrated circuits, microprocessors, microcontrollers, memory circuits, passive and active electronic components, as well as optical components.

The conditional handover controller (109) receives the handover request message from the source MN for performing the handover. The handover request message includes the SCPAC configuration. Further, the conditional handover controller (109) determines to maintain the subsequent CAPC configuration received in the handover request message. Further, the conditional handover controller (109) creates the RRC reconfiguration message by including a ReconfigurationwithSync and the conditional reconfiguration. This allows an optimal configuration of SCPAC along with the PCell handover, as the MN doesn't have to release and again add the SCPAC configuration, but MN just needs to provide the conditional reconfiguration with the changed parameters. This also ensures that the security is not compromised at the UE, The target MN includes the conditional reconfiguration for maintaining the SCPAC configuration during the handover. Further, the conditional handover controller (109) transmits the HO ACK message to the source MN. The HO ACK message includes the RRC reconfiguration message.

In an embodiment, the conditional handover controller (109) adds the sk-counter configuration in the conditional Reconfiguration. The sk-counter configuration includes a sk-counter list.

In an embodiment, the RRC reconfiguration message includes the masterkeyupdate.

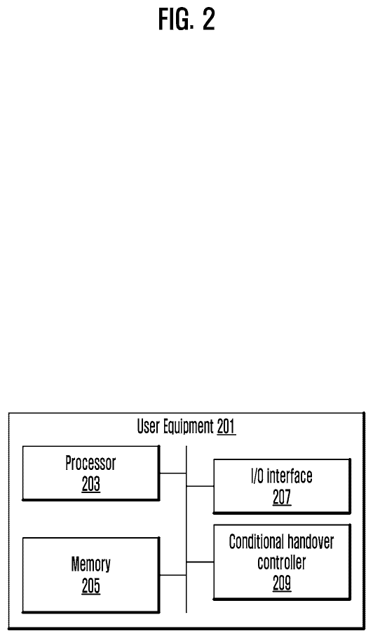

FIG. 2 is the block diagram of UE for performing the handover while maintaining SCPAC configuration in a communication system according to an embodiment of the disclosure. The UE (201) includes a processor (203), memory (205), an I/O interface (207), and a conditional handover controller (209). The UE is a device that is used by an end-user to communicate with a mobile network. The UE (201) can be, but is not limited to, mobile phones, tablets, laptops, and Internet of Things (IoT) devices. Furthermore, the processor (203) of the UE (201) communicates with the memory (205), the I/O interface (207), and the conditional handover controller (209). The processor (203) is configured to execute instructions stored in the memory (205) and to perform various processes. The processor (203) can include one or a plurality of processors, can be a general-purpose processor such as a central processing unit (CPU), an application processor (AP), or the like, a graphics-only processing unit such as a graphics processing unit (GPU), a visual processing unit (VPU), and/or an Artificial Intelligence (AI) dedicated processor such as a neural processing unit (NPU).

Furthermore, the memory (205) of the UE (201) includes storage locations that can be addressed through the processor (203). The memory (205) is not limited to volatile or non-volatile memory and can include one or more computer-readable storage media. Non-volatile storage elements such as magnetic hard disks, optical discs, floppy discs, flash memories, EPROM, or EEPROM memories can also be included in the memory (205). Further, the memory (205) of the UE (201) can store various information received from the target master node (101) and source master node. The UE (201) can store several pieces of information such as ReconfigurationwithSync and conditional reconfiguration received in the RRC reconfiguration message and the like.

The I/O interface (207) transmits information between the memory (205) and external peripheral devices, which are input-output devices associated with the UE (201). The I/O interface (207) receives various information from the target MN (101) and the source MN. This interface is used to maintain seamless communication between the UE (201) and external devices, ensuring that data is transmitted and received. Additionally, the I/O interface (207) facilitates the integration of the UE (201) with other network components, enhancing its capability to prepare a handover while maintaining SCPAC in the communication system.

The conditional handover controller (209) communicates with the I/O interface (207) and the memory (205) for performing a handover while maintaining SCPAC in the communication system. The conditional handover controller (209) is an innovative hardware that is realized through the physical implementation of both analog and digital circuits, including logic gates, integrated circuits, microprocessors, microcontrollers, memory circuits, passive and active electronic components, as well as optical components.

The conditional handover controller (209) receives the RRC reconfiguration message from the source MN to perform handover. The RRC reconfiguration message includes the ReconfigurationwithSync and the conditional reconfiguration. Further, the conditional handover controller (209) performs handover based on the ReconfigurationwithSync and the conditional reconfiguration.

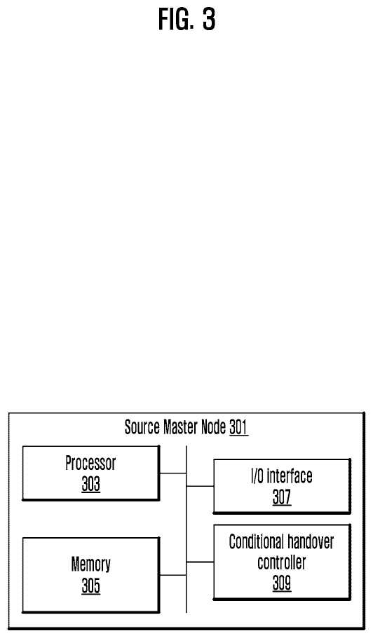

FIG. 3 is the block diagram of the Source Master node for performing the handover while maintaining SCPAC configuration in a communication system according to an embodiment of the disclosure. The source master node (301) is a primary network node that is currently serving the UE (201) before the handover or reconfiguration procedure. For example, the source master node (301) can be, but is not limited to, a gNodeB, eNodeB, and base station. The source master node (301) includes a processor (303), memory (305), an I/O interface (307), and a conditional handover controller (309). Furthermore, the processor (303) of the source master node (301) communicates with the memory (305), the I/O interface (307), and the conditional handover controller (309). The processor (303) is configured to execute instructions stored in the memory (305) and to perform various processes. The processor (303) can include one or a plurality of processors, can be a general-purpose processor such as a central processing unit (CPU), an application processor (AP), or the like, a graphics-only processing unit such as a graphics processing unit (GPU), a visual processing unit (VPU), and/or an Artificial Intelligence (AI) dedicated processor such as a neural processing unit (NPU).

Furthermore, the memory (305) of the source master node (301) includes storage locations that can be addressed through the processor (303). The memory (305) is not limited to volatile or non-volatile memory and can include one or more computer-readable storage media. Non-volatile storage elements such as magnetic hard disks, optical discs, floppy discs, flash memories, EPROM, or EEPROM memories can also be included in the memory (305). Further, the memory (305) of the source master node (301) can store various information received from the UE (201) and the target master node (101). The source master node (301) can store several pieces of information such as SCPAC configuration, the ReconfigurationwithSync, and the conditional reconfiguration and the like.

The I/O interface (307) transmits information between the memory (305) and external peripheral devices, which are input-output devices associated with the source master node (301). The I/O interface (307) receives various information from the UE (201) and the target master node (101). This interface is used to maintain seamless communication between the source master node (301) and external devices, ensuring that data is transmitted and received. Additionally, the I/O interface (307) facilitates the integration of the source master node (301) with other network components, enhancing its capability for performing handover while maintaining the SCPAC configuration in the communication system.

The conditional handover controller (309) communicates with the I/O interface (307) and the memory (305) for performing a handover while maintaining the SCPAC configuration in the communication system. The conditional handover controller (309) is an innovative hardware that is realized through the physical implementation of both analog and digital circuits, including logic gates, integrated circuits, microprocessors, microcontrollers, memory circuits, passive and active electronic components, as well as optical components.

The conditional handover controller (309) transmits the handover request message to the target MN (101) for performing the handover. The handover request message includes the SCPAC configuration. Further, the conditional handover controller (309) receives the handover acknowledgment message from the target MN (101). The HO ACK message includes the RRC reconfiguration message. Further, the conditional handover controller (309) transmits the RRC reconfiguration message to UE (201) to perform the handover from the source MN (301) to the target MN (101). The RRC reconfiguration message includes the ReconfigurationwithSync and the conditional reconfiguration.

In the proposed disclosure, the ReconfigurationwithSync is included in the conditional reconfiguration for maintaining the SCPAC configuration. The maintaining of the SCPAC configuration helps to avoid frequent reconfigurations during PSCellChange and thus increases the reliability of mobility and optimizes the signaling overhead.

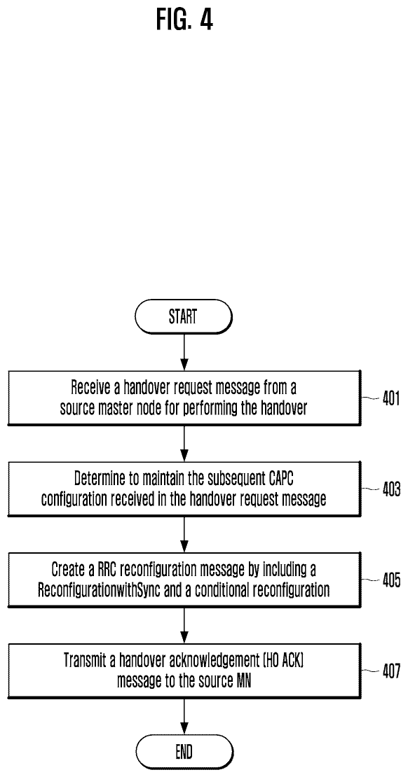

FIG. 4 is the flow diagram that illustrates the method for performing handover while maintaining SCPAC configuration in a communication system by the target master node according to an embodiment of the disclosure.

At block 401, the method includes receiving the handover request message from the source MN (301) for performing the handover. The handover request message includes the SCPAC configuration.

At block 403, the method includes determining to maintain the subsequent SCPAC configuration received in the handover request message.

At block 405, the method includes creating the RRC reconfiguration message by including the ReconfigurationwithSync and the conditional reconfiguration. The target MN (101) includes the conditional reconfiguration for maintaining the SCPAC configuration during the handover.

At block 407, the method includes transmitting the HO ACK message to the source MN (301). The HO ACK message includes the RRC reconfiguration message.

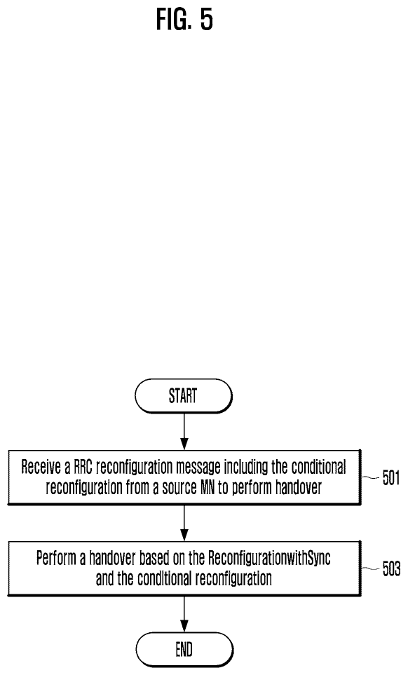

FIG. 5 is a flow diagram that illustrates the method for performing handover while maintaining SCPAC configuration in a communication system by UE according to an embodiment of the disclosure.

At block 501, the method includes receiving the RRC reconfiguration message from the source MN (301) to perform handover. The RRC reconfiguration message includes the ReconfigurationwithSync and the conditional reconfiguration.

At block 503, the method includes performing the handover based on the ReconfigurationwithSync and the conditional reconfiguration included in the RRC reconfiguration message.

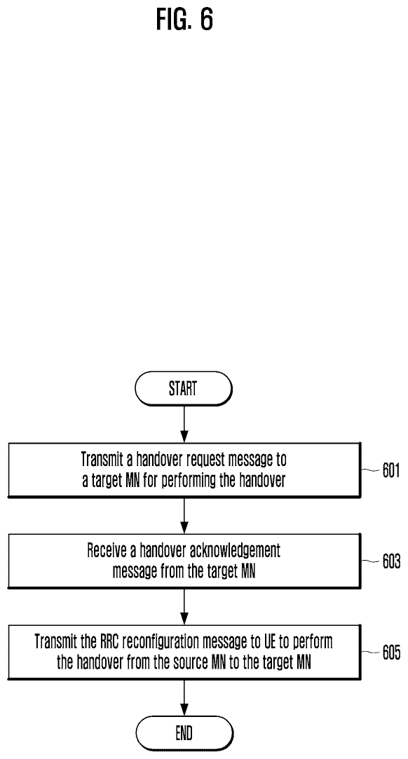

FIG. 6 is a flow diagram that illustrates the method for performing handover while maintaining SCPAC configuration in a communication system by the source master node according to an embodiment of the disclosure.

At block 601, the method includes transmitting the handover request message to the target MN (101) for performing the handover of the UE (201). The handover request message includes the SCPAC configuration.

At block 603, the method includes receiving the handover acknowledgement message from the target MN (101). The handover acknowledgement message indicates that the target MN (101) is ready for providing the service to the UE (201) and is successfully prepared for the handover of the UE (201). The HO ACK message includes the RRC reconfiguration message that includes the ReconfigurationwithSync and the conditional reconfiguration.

At block 605, the method includes transmitting the RRC reconfiguration message to the UE (201) to perform the handover from the source MN (301) to the target MN (101) upon receiving the HO ACK message. The RRC reconfiguration message includes the ReconfigurationwithSync and the conditional reconfiguration that is required to perform the handover.

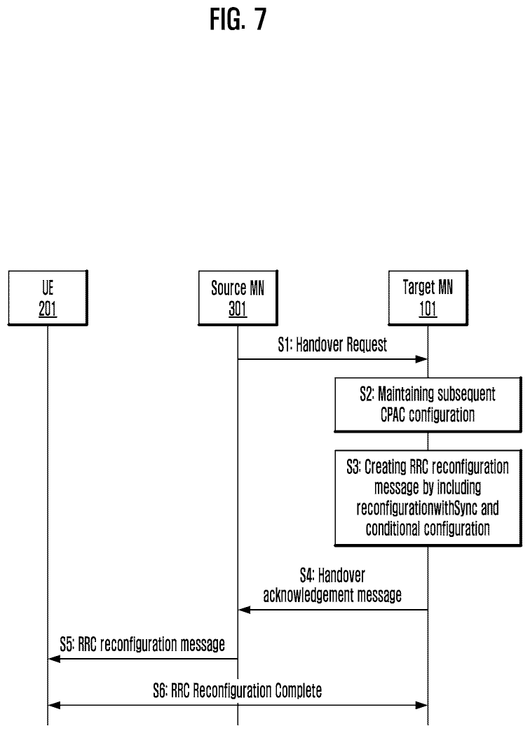

FIG. 7 is a sequence diagram that illustrates the sequence of performing handover while maintaining SCPAC configuration in communication system, according to an embodiment of the disclosure.

At step S1, the source MN (301) sends the handover request message to the target MN (101) to initiate the handover process for the UE (201). The handover request message includes the SCPAC configuration. The SCPAC configuration indicates the configuration for performing Subsequent Conditional PSCell Addition or PSCell Change.

Further, at step S2, upon receiving the handover request message, the target MN (101) decides to maintain the SCPAC configuration received in the handover request message.

At step S3, the target MN (101) creates the RRC reconfiguration message by including the ReconfigurationwithSync and the conditional reconfiguration for maintaining the SCPAC configuration during the handover.

At step S4, the target MN (101) transmits the HO ACK message to the source MN (301). The HO ACK message includes the RRC reconfiguration message. The HO ACK message indicates that the target MN (101) is ready for providing the service to the UE (201) and is successfully prepared for the handover of the UE (201).

Further, at step S5, the source MN (301) forwards the RRC reconfiguration message to the UE (201) to perform the handover from the source MN (301) to the target MN (101). The RRC reconfiguration message includes the ReconfigurationwithSync and the conditional reconfiguration. The RRC reconfiguration message is transmitted to the UE (201) to initiate the handover process and prepare for transitioning to the target MN (101).

At step S6, upon receiving the RRC Reconfiguration message the UE (201) sends RRC Reconfiguration complete message to initiate the handover from the source MN (301) to the target MN (101).

A Subsequent Conditional PSCell Addition or Change (subsequent CPAC) is defined as a conditional PSCell addition or change procedure that is executed after a PSCell addition, a PSCell change, a PCell change or an SCG release based on pre-configured subsequent CPAC configuration of candidate PSCell(s) without reconfiguration and re-initiation of CPC/CPA. The UE (201) keeps the configured subsequent CPAC configuration (unless the network indicates to release it) and evaluates the execution conditions of candidate PSCells after completion of a PSCell addition, a PSCell change, a PCell change or an SCG release. Intra-SN subsequent CPAC initiated by the SN, inter-SN subsequent CPAC initiated by either MN or SN are supported.

In wireless technologies like NR and LTE, a RRC connected UE (201) performs various measurements for RRM purpose, positioning etc. For RRM, UE measures the reference signals such as SSB, CSI-RS etc. and reports the network. When the UE (201) needs to measure inter frequency NR or inter-RAT measurements or intra frequency measurements outside the active downlink BWP when SSB is not completely contained in the active DL BWP, UE (201) may use measurement gaps. Measurement gaps are configured by the network (for e.g. gNB in NR) and there will not be any transmission or reception during the gap period. Measurement gap configuration includes a gap offset, gap length, and repetition period and measurement gap timing advance. Gap offset specifies the sub-frame where the measurement gap occurs. Gap length gives the duration of the gap while the repetition period defines how often the measurement gap can occur.

3gpp Release18 also introduced multi-sim operations for devices which can support at least two USIMs in which both can be in RRC_CONNECTED. UE (201) can be configured by the network (for e.g. using musim-CapRestrictionInd in TS 38.331V18.0.0) to send temporary capability restrictions using RRC messages such RRCReconfiguration. The UE (201) can send a UEAssistanceInformation (UAI) message to inform the network about the capability restrictions after the configuration. There is no processing delay requirements for UAI in TS 38.331. UE (201) also can send early indication of temporary capability restriction in the RRCSetupComplete and RRCResumeComplete. The UE can include a field such as musim-CapRestrictionInd as specified in the TS 38.331,in RRCSetupComplete or RRCResumeComplete message upon determining it has temporary capability restriction.

In an embodiment, the gNB sends conditional reconfiguration (such as conditionalReconfiguration IE in NR) to the UE (201) to add or modify or release sk-CounterConfiguration. The masterCellGroup includes Reconfiguration WithSync.

Configuration of candidate target SpCell(s) and execution condition(s) for conditional handover, conditional PSCell addition or conditional PSCell change. The field is absent if any DAPS bearer is configured or if the masterCellGroup includes Reconfiguration WithSync except sk-counterConfiguration or if the sl-L2RemoteUE-Config or sl-L2RelayUE-Config is configured. For conditional PSCell change, the field is absent if the secondaryCellGroup includes Reconfiguration WithSync. The RRCReconfiguration message contained in DLInformationTransferMRDC cannot contain the field conditionalReconfiguration for conditional PSCell change or for conditional PSCell addition.

In an embodiment, while sending masterkeyupdate, MN includes a new sk-counter list for the subsequent CPAC (i.e. a new sk-counterConfiguration is send in NR) in RRCReconfiguration message including ReconfigurationWithSync.sk-CounterConfiguration may be included in conditionalReconfiguration IE in NR.

In an embodiment, while sending masterkeyupdate, MN includes a new sk-counter for the CPAC (i.e. a new sk-counter value) in RRCReconfiguration message including Reconfiguration WithSync.sk-Counter may be included in conditionalReconfiguration IE in NR.

In an embodiment, gNB may not include a new sk-counter value for a PSCellChange triggered by itself (i.e. not subsequent CPAC) during an Intra-SN PSCellChange, and the UE (201) and the SN uses the sk-counter value selected from sk-counterConfiguration for the previous PSCellChange. In an embodiment, 3gpp proposes to perform LTM, without reset of lower layers like MAC to avoid data loss and to reduce the additional delay of data recovery wherever it is possible.

In an embodiment, a gNB centralized unit (CU) may provide LTMCandidateConfiguration, to configure LTM candidate cells through one RRCReconfiguration message for a candidate target cell. The gNB may further release or modify the candidate configurations. A UE can store the LTM configuration of other candidate cells even after moving to a candidate cell through LTM. The gNB CU also may provide the UE with configuration for performing LTM measurements (L1 measurements required for LTM) for different candidate frequencies and candidate cells and reporting based on the performed LTM measurements. gNB may further release or modify the candidate configurations. A UE can store the LTM configuration of other candidate cells even after moving to a candidate cell through LTM. gNB also may provide the UE with configuration for performing LTM measurements for different candidate frequencies and candidate cells and reporting based on the performed LTM measurements. 3gpp supports subsequent LTM, and after one LTM candidate cell becomes a source cell due to LTM, the UE can store LTM candidate configuration and continue to report LTM measurements (L1 measurements for LTM) and the new serving cell may send LTM cell switch command to the UE and UE performs LTM. Such an LTM is called subsequent LTM.

The UE (201) performs the L1 measurements on the source cell and candidate cell and report L1 measurements through CSI reports to the gNB DU of the source cell. gNB DU may send a MAC CE (for e.g. LTM MAC CE or cell switch MAC CE) asking the UE to switch to another cell which is a LTM candidate cell. UE may perform random access during LTM cell switch, or the cell switch may be RACH less. The CellSwitch may be guarded by a timer. UE may be requested to perform random access on a candidate cell before the cell switch, so that the network can calculate the timing advance before the cell switch and inform the UE either through a random access response or within the MAC CE which is send for the cell switch. The gNB may configure the UE to perform random access towards one or more LTM candidate cells for receiving the timing advance (TA) before the cell switch is performed (known as Early TA or Early Sync TA or TA for Early Sync). Random access performed on LTM candidate cells for the timing advance reception is known as random access for early TA. gNB sends a PDCCH order to initiate RACH for TA measurement for candidate cells. The UE receives PDCCH order from the serving cell. Upon reception of this PDCCH order, UE initiates RACH for TA measurement for candidate cells on the one or more candidate cell. UE sends RACH preamble to the candidate cells and receives the Timing Advance (TA) value from the candidate cell. TA for candidate cells may be received from the source cell also. Normally, TA will be received in the random access response, but it may be also received through a MAC CE. If source DU indicates the UE to retransmit the RACH for early TA, UE retransmits the same. The gNB may also send PDCCH order to retransmit RACH for TA measurement (also known as RACH for early sync).

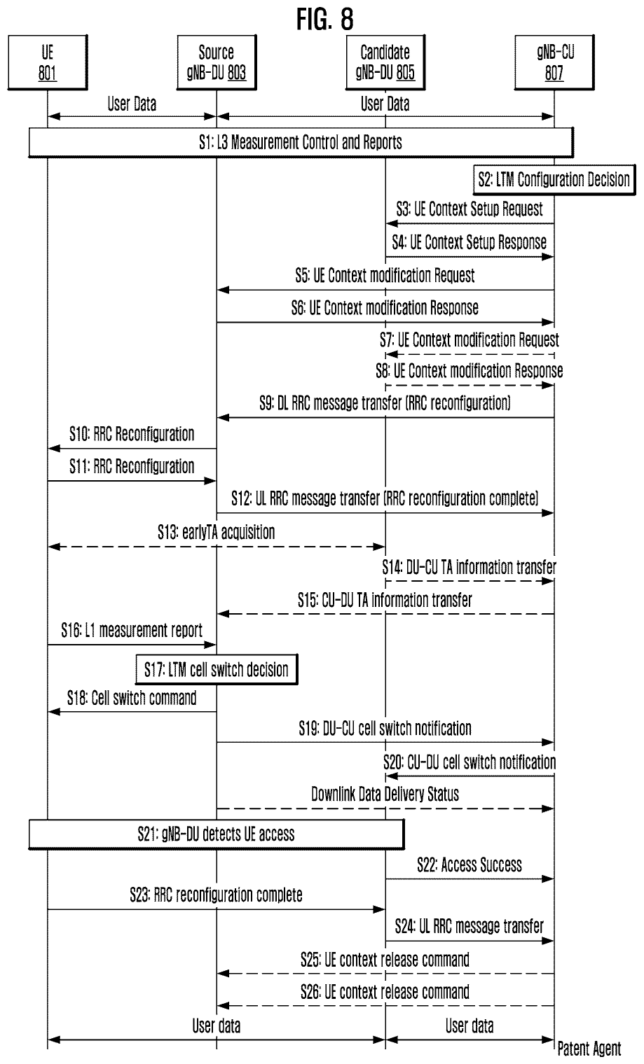

FIG. 8 is a sequence diagram that illustrates the LTM procedure, according to an embodiment of the disclosure.

At step S1, a L3 measurement control and reports is performed by the UE (801).

At step S2, a gNB-CU (807) performs a decision on LTM configuration.

At step S3, the gNB-CU sends a UE context setup request message to a candidate gNB-DU (805).

At step S4, in response, the candidate gNB-DU (805) sends a UE context setup response message.

At step S5, the gNB CU (807) sends the UE Context modification Request message to the source gNB DU (803).

At step S6, the source gNB DU (803) sends the UE Context modification response message to the gNB-CU (807).

At step S7, the gNB CU (807) sends a UE Context modification Request message to the candidate gNB DU (805).

At step S8, the candidate gNB DU (805) sends a UE Context modification response message to the gNB CU (807).

At step S9, the gNB CU (807) sends the DL RRC message transfer in the RRC reconfiguration message to source gNB-DU (803).

At step S10, the source gNB-DU (803) sends the RRC reconfiguration message to the UE (801).

At step S11, the UE (801) sends the RRC reconfiguration complete message to the source gNB-DU (803).

At step S12, the source gNB DU (803) sends a UL RRC message transfer in the RRC Reconfiguration to the gNB CU (807).

At step S13, an earlyTAacquisition process is performed between the UE (801) and the candidate gNB DU (805).

At step S14, the candidate gNB DU (805) sends a DU-CU TA information transfer message to the gNB CU (807).

At step S15, the gNB CU (807) sends a CU-DU data information transfer to the source gNB DU (803).

At step S16, the UE (801) sends a L1 measurement report to the source gNB DU (803).

At step S17, the source gNB DU (803) performs a LTM cell switch decision.

At step S18, the source gNB DU (803) sends a cell switch command to the UE (801).

At step S19, the source gNB DU (803) sends a DU-CU cell switch notification message to the gNB CU (807). The DU-CU cell switch notification message includes a target cell ID and TCI state ID.

At step S20, the gNB CU (807) sends a CU-DU cell switch notification message to the candidate gNB DU (805). The CU-DU cell switch notification message includes the target cell ID and TCI state ID.

At step S21, the gNB DU (805) detects the UE access.

At step S22, the candidate gNB DU (805) sends a access success message to the gNB CU (807). The access success message includes the target cell ID.

At step S23, the UE (801) sends the RRC reconfiguration complete message to the candidate gNB DU (805).

At step S24, the candidate gNB DU (805) sends a UL RRC message transfer to the gNB CU (807) in the RRC reconfiguration complete message.

At step S25, the gNB CU (807) sends the UE context release command to the source gNB DU (803) that includes the prepared cells that are to be released.

At step S26, the source gNB DU (803) sends a UE context release complete message to the gNB CU (807).

LTM is a procedure in which a gNB receives L1 measurement report(s) from a UE (801), and on their basis the gNB changes UE's (801) serving cell by a cell switch command signaled via a MAC CE. The cell switch command indicates an LTM candidate cell configuration that the gNB previously prepared and provided to the UE (801) through RRC signaling. Then the UE (801) switches to the target cell according to the cell switch command. The LTM procedure can be used to reduce the mobility latency as described. The Network may request the UE (801) to perform early TA acquisition of a candidate cell before a cell switch. The early TA acquisition is triggered by PDCCH order [or through UE-based TA measurement].

The network indicates in the cell switch command whether the UE shall access the target cell with a RA procedure if a TA value is not provided or with PUSCH transmission using the indicated TA value. For RACH-less LTM, the UE either monitors PDCCH for dynamic scheduling from the target cell upon LTM cell switch, or the UE selects the configured grant occasion associated with the beam indicated in the cell switch command. The following principles apply to LTM:

The UE doesn't update its security key in LTM.

Subsequent LTM is supported.

The LTM supports both intra-gNB-DU and intra-gNB-CU inter-gNB-DU mobility. LTM also supports inter-frequency mobility, including mobility to inter-frequency cell that is not a current serving cell. The scenarios that is supported are PCell change in non-CA scenario, PCell change in CA scenario, Dual connectivity scenario, at least for the PSCell change without MN involvement case, i.e. intra-SN PSCell change.

A supervision timer can be used to detect failure of LTM cell switch procedure, wherein LTM procedure fails if the LTM supervision timer expires, upon which the UE (801) initiates RRC connection re-establishment procedure.

While the UE (801) has stored LTM candidate cell configurations the UE (801) can also execute any L3 handover command sent by the network. It is up to the network to avoid any issue due to a collision between LTM execution and L3 handover execution, e.g. avoiding sending LTM cell switch command and L3 handover command simultaneously.

Cell switch command is conveyed in a MAC CE, which contains the necessary information to perform the LTM cell switch.

For the purpose of proposed disclosure, 3gpp specifications such as TS38.300, TS38.331, TS 38.321 V18.0.0 is considered as relevant background.

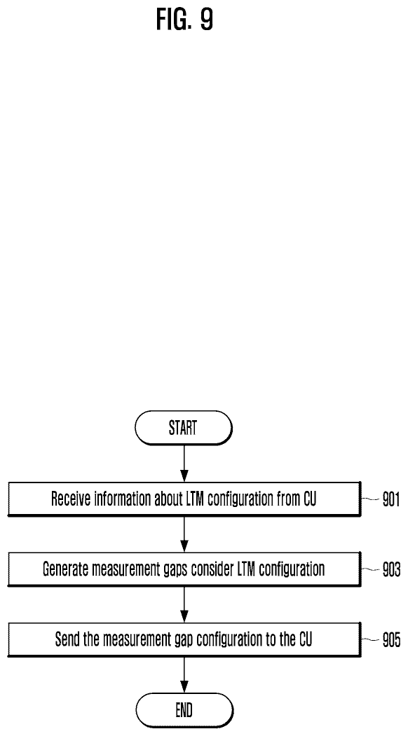

FIG. 9 is the flow diagram that illustrates DU operations for LTM measurement gaps handling, according to an embodiment of the disclosure.

At block 901, receiving information about LTM configuration from CU (807).

At block 903, the method includes generating measurement gaps by considering the received LTM configurations.

At block 905, the method includes sending the generated measurement gap configuration to the CU (807) that includes the generated measurement gaps.

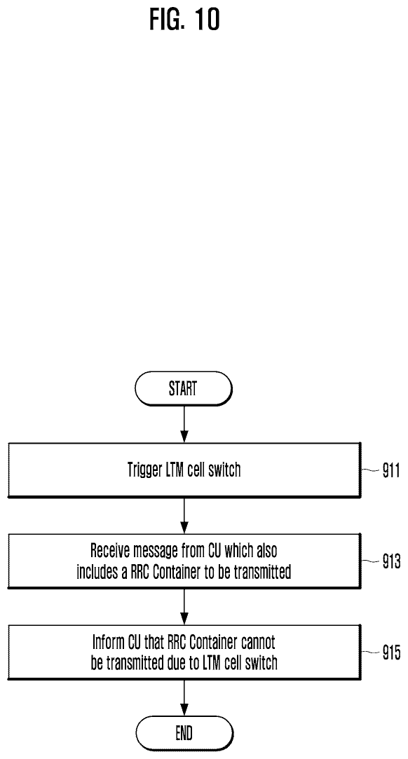

FIG. 10 is the flow diagram that illustrates DU operations for sending RRC message to UE, according to an embodiment of the disclosure.

At block 911, the method includes triggering an LTM cell switch to the UE (801).

At block 913, the method includes receiving message from the CU (807) that includes a RRC container to be transmitted to the UE (801).

At block 915, the method includes informing the UE (801) that the RRCcontainer cannot be transmitted due to the LTM cell switch.

In an embodiment, if the gNB DU (803) receives FIAP UEContextModification Request including RRC container from the gNB CU (807) after gNB DU (803) has triggered LTM cell switch command to the UE (801), gNB DU (803) avoids sending RRCContainer to the UE (801) and sends F1AP UEContextModificaion Failure including the cause which informs the CU that the (failure is due to) LTM is triggered (Radio network layer cause: LTM triggered).

In an embodiment, if the gNB DU (803) receives FIAP UEContextRelease Request including RRC container from gNB CU (807) after gNB DU (803) has triggered LTM cell switch command to the UE (801), gNB DU (803) avoids sending RRCContainer to the UE (801) and informs CU (807) that the transfer of RRCContainer has failed. DU (803) also includes the cause which informs the CU (807) that the (failure is due to) LTM is triggered (Radio network layer cause: LTM triggered).

In an embodiment, if the gNB DU (803) receives F1AP message (such as F1AP UEContextModificaion Request) indicating to release LTM configuration from gNB CU (807) after gNB DU (803) has triggered LTM cell switch command to the UE (801), Gnb DU (803) informs the CU (807) that LTM is already triggered. In an embodiment, gNB sends a failure response message.

In an embodiment, gNB DU (803) generates the measurement gaps needed for LTM. In an embodiment, gNB-DU (803) sends the measurement gaps information to the gNB-CU (807) in the MeasGapConfig IE of the DU (803) to CU (807) RRC Information IE that is included in the UE CONTEXT SETUP RESPONSE message.

In an embodiment, gNB CU (807) receives the measurement gap requirements for LTM, measurement gaps and NCSG requirements for LTM and whether interruptions are needed for LTM measurements from the UE (801) (i.e. UE informs the CU through RRC message). In an embodiment gNB CU (807) sends these received information to the gNB DU (803). In an embodiment, gNB DU (803) generates the measurement gaps based on the received measurement gap requirements for LTM, measurement gaps and NCSG requirements for LTM and whether interruptions are needed for LTM measurements.

In an embodiment, gNB DU (803) decides if the measurement gaps are required based on the received LTM configuration or part of the LTM configuration like NR-ARFCN, PCI, SSB frequency and timing etc. and generates the measurement gaps.

In an embodiment, gNB CU (807) includes the received measurement gaps from gNB DU (803) in the RRCReconfiguration message and sends to UE (801).

In an embodiment, gNB DU (803) receives SSB time and frequency information for LTM from the gNB CU (807) for the LTM candidate cells and for the source cell and uses this information for generating measurement gaps.

In an embodiment, gNB CU (807) provides the NR-ARFCN (frequency), Sub Carrier Spacing (SCS) and PCI of the LTM candidate cell to gNB DU (803). In an embodiment, this may be provided in the FIAP UE Context Setup Request and FIAP UE Context Modification Request messages.

In an embodiment, gNB CU (807) provides CSI-RS configuration which may be used by the UE (801) for performing LTM measurements to the gNB DU (803). In an embodiment, gNB CU (807) provides different CSI-RS configurations, one which may be used by the UE (801) for performing LTM measurements and other which may be used for reporting LTM measurements to the gNB DU (803).

In an embodiment, the generated measurement gap configuration which is informed to gNB CU (807) from gNB DU (803) includes at least measurement gap identifier, applicable for a NR-ARFCN and the gNB CU (807) includes the measurement gap identifier in the LTM measurement configuration send to the UE such as:

Configurations for L1 measurement RS provided under ServingCellConfig for the serving cells

Configurations for L1 measurement RS provided separately from ServingCellConfig for the serving cells and CellGroupConfig for the candidate cells

Configurations for L1 measurement RS provided under CellGroupConfig for the candidate cells

L3 measurement configuration such as MeasObjectNR which can be used for identifying the reference signal and/or NR ARFCN for the measurements for LTM.

In an embodiment, gNB DU (803) informs the gNB CU (807) the measurement gap configuration including at least measurement gap identifier, applicable for a reference signal (in NR-ARFCN) and the gNB CU (807) includes the measurement gap identifier in the LTM measurement configuration send to the UE (801) such as:

Configurations for L1 measurement RS provided under ServingCellConfig for the serving cells

Configurations for L1 measurement RS provided separately from ServingCellConfig for the serving cells and CellGroupConfig for the candidate cells

Configurations for L1 measurement RS provided under CellGroupConfig for the candidate cells

L3 measurement configuration such as MeasObjectNR which can be used for identifying the reference signal and/or NR ARFCN for the measurements for LTM.

In an embodiment, gNB DU (803) determines the gap sharing and gap priority for the measurement gaps which are used for performing LTM measurements.

In an embodiment, if the gNB DU (803) generates measurement gaps for performing LTM measurements, it avoids configuring concurrent measurement gaps (concurrent measurement gaps are defined in TS 38.133).

In an embodiment, if the gNB DU (803) generates measurement gaps for performing LTM measurements, it avoids configuring NCSG (NCSG are defined in TS 38.133).

In an embodiment, if the gNB DU (803) generates measurement gaps for performing LTM measurements, it avoids configuring interruptions (NCSG are defined in TS 38.133).

For inter-frequency layer, during each layer 1 measurement period, the UE (801) shall be capable of performing L1-RSRP measurements for at least N cells/SSBs based on UE capability. In an embodiment, the gNB DU (803) generates measurement gaps for performing LTM measurements based on this UE capability.

In an embodiment, gNB DU (803) generates the measurement gaps based on the measurement configuration IE received from gNB CU (807) and the LTM configuration received from the gNB CU (807). In an embodiment, the gNB DU (803) in the above embodiments is the DU of the source cell. In an alternate embodiment, gNB DU can be both the DU of the source cell (803) and the candidate cell (805). In an embodiment, gNB (803, 805) configures LTM configuration to the UE (801) for only the frequencies or frequency layers that are included in the layer 3 measurement configuration.

In an embodiment, gNB CU (807) configures LTM configuration to the gNB DU (803) for only the frequencies or frequency layers that are included in the layer 3 measurement configuration. The frequency layers (as specified in 3gpp specifications such as TS 38.331, TS 38.133, TS 38.473) from LTM configuration send by gNB CU (807) to gNB DU (803) will be a subset of the frequency layers configured through MeasConfig IE.

In an embodiment, MN configures LTM configuration to the UE (801) for only the frequencies or frequency layers that are included in the layer 3 measurement configuration by itself. In an embodiment, gNB CU (807) of MN configures LTM configuration to the gNB DU (803) of MN for only the frequencies or frequency layers that are included in the layer 3 measurement configuration by itself. The frequency layers (as specified in 3gpp specifications such as TS 38.331, TS 38.133, TS 38.473) from LTM configuration send by gNB CU to gNB DU will be a subset of the frequency layers configured through MeasConfig IE.

In an embodiment, MN configures LTM configuration to the UE (801) for only the frequencies or frequency layers that are included in the layer 3 measurement configuration by itself. In an embodiment, gNB CU (807) of MN configures LTM configuration to the gNB DU (803) of MN for only the frequencies or frequency layers that are included in the layer 3 measurement configuration by itself. The frequency layers (as specified in 3gpp specifications such as TS 38.331, TS 38.133, TS 38.473) from LTM configuration send by gNB CU (807) to gNB DU (803) will be a subset of the frequency layers configured through MeasConfig IE.

In an embodiment, SN configures LTM configuration to the UE (801) for only the frequencies or frequency layers that are included in the layer 3 measurement configuration by itself. In an embodiment, gNB CU (807) of SN configures LTM configuration to the gNB DU (805) of SN for only the frequencies or frequency layers that are included in the layer 3 measurement configuration by itself. The frequency layers (as specified in 3gpp specifications such as TS 38.331, TS 38.133, TS 38.473) from LTM configuration send by gNB CU (807) to gNB DU (803) will be a subset of the frequency layers configured through MeasConfig IE.

In an embodiment, SN configures LTM configuration to the UE (801) for only the frequencies or frequency layers that are included in the layer 3 measurement configuration by MN or SN. In an embodiment, gNB CU (807) of SN configures LTM configuration to the gNB DU (803, 805) of SN for only the frequencies or frequency layers that are included in the layer 3 measurement configuration by MN or SN. The frequency layers (as specified in 3gpp specifications such as TS 38.331, TS 38.133, TS 38.473) from LTM configuration send by gNB CU (807) to gNB DU (803, 805) will be a subset of the frequency layers configured through MeasConfig IE. In an embodiment, the gNB DU in the above embodiments can be either the DU of the source cell or the DU of any of the candidate cells. In an embodiment, a UE (801) supporting LTM, sends interFrequencyConfig-NoGap-r16 (as specified in TS 38.331) only if it can perform Inter-frequency measurements for LTM without gaps.

In an embodiment, upon the completion of LTM execution, source CU (807) informs the candidate DU's (805) the information about the new source DU (803). At the end of LTM execution, source CU (807) informs candidate DU's (805) about the new source DU identifier. In an embodiment, source CU (807) sends F1AP UE Context Modification Request upon completion of LTM cell switch. In an embodiment, this is to modify the source DU Identifier to the candidate Dus (805). In an embodiment, source DU Identifier may be sent to only the candidate DUs (805) which is not source DU (803) after LTM cell switch. In an embodiment, source DU Identifier may be sent to only the candidate DUs (805) which is not source DU (803) before/after LTM cell switch. In an embodiment, upon the completion of LTM execution, source CU (807) informs the candidate DU's (805) the information about the new source cell. In an embodiment, source CU (807) sends F1AP UE Context Modification Request to inform the new source cell to the candidate Dus (805).

In an embodiment, a MUSIM UE which has send early indication of temporary capability restrictions in RRCSetupComplete or RRCResumeComplete (such as musim-CapRestrictionInd) and received a configuration for reporting temporary capability restrictions (such as MUSIM-CapRestriction in TS 38.331V18.0.0) has a processing delay requirement of a specified duration (such as X ms). In an embodiment, the processing delay requirement, X is 80 ms. In an embodiment, the processing delay requirement, X is a few ms such as 10 ms or 16 ms. UE sends UAI including the temporary capability restrictions (or removal of the same) within X ms after receiving the configuration for reporting temporary capability restrictions (such as MUSIM-CapabilityRestrictionConfig), if it has reported early indication of temporary capability restrictions. If the UE has not sent early indication of temporary capability restrictions, there is no processing delay requirement for UAI. If the UE has not sent early indication of temporary capability restrictions, there is processing delay requirement for sending UAI to indicate temporary capability restrictions or removal of temporary capability restrictions. gNB is used generically to indicate a Radio Access Node and gNB CU/gNB DU to any components of Radio Access Node which has equivalent functionality of gNB CU or gNB DU in NR

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a communication system, the method comprising:
receiving, from a base station, a message comprising information on a conditional reconfiguration; and
performing at least one of an addition, a modification, or a removal for a list of a security key (sk) counter,
wherein, in case that the message comprises information on a reconfiguration with sync, the information on the conditional reconfiguration comprises information on a sk-counter configuration.

2. The method of claim 1,
wherein, the message comprises information on a master cell group, and
wherein, in case that the information on a master cell group comprises the information on the reconfiguration with sync, the information on the conditional reconfiguration comprises configurations associated with a subsequent conditional primary secondary cell (PSCell) addition or change (CPAC).

3. The method of claim 1, wherein the information on the sk-counter configuration comprises the list of sk-counter.

4. The method of claim 1, wherein the message comprises a radio resource control (RRC) reconfiguration message.

5. A method performed by a base station in a communication system, the method comprising:
identifying that a message comprises information on a reconfiguration with sync; and
transmitting, to a terminal, the message comprising information on a conditional reconfiguration,
wherein, in case that the message comprises the information on the reconfiguration with sync, the information on the conditional reconfiguration comprises information on a security key (sk) counter configuration, and
wherein a list of an sk counter is performed at least one of an addition, a modification, or a removal by the terminal.

6. The method of claim 5,
wherein, the message comprises information on a master cell group, and
wherein, in case that the information on a master cell group comprises the information on the reconfiguration with sync, the information on the conditional reconfiguration comprises configurations associated with a subsequent conditional primary secondary cell (PSCell) addition or change (CPAC).

7. The method of claim 5,
wherein the information on the sk-counter configuration comprises the list of sk-counter, and
wherein the message comprises a radio resource control (RRC) reconfiguration message.

8. A terminal in a communication system, the terminal comprising:
a transceiver; and
at least one processor coupled with the transceiver and configured to:
receive, from a base station, a message comprising information on a conditional reconfiguration, and
perform at least one of an addition, a modification, or a removal for a list of a security key (sk) counter,
wherein, in case that the message comprises information on a reconfiguration with sync, the information on the conditional reconfiguration comprises information on a sk-counter configuration.

9. The terminal of claim 8,
wherein, the message comprises information on a master cell group, and
wherein, in case that the information on a master cell group comprises the information on the reconfiguration with sync, the information on the conditional reconfiguration comprises configurations associated with a subsequent conditional primary secondary cell (PSCell) addition or change (CPAC).

10. The terminal of claim 8, wherein the information on the sk-counter configuration comprises the list of sk-counter.

11. The terminal of claim 8, wherein the message comprises a radio resource control (RRC) reconfiguration message.

12. A base station in a communication system, the base station comprising:
a transceiver; and
at least one processor coupled with the transceiver and configured to:
identify that a message comprises information on a reconfiguration with sync, and
transmit, to a terminal, the message comprising information on a conditional reconfiguration,
wherein, in case that the message comprises the information on the reconfiguration with sync, the information on the conditional reconfiguration comprises information on a security key (sk) counter configuration, and
wherein a list of an sk counter is performed at least one of an addition, a modification, or a removal by the terminal.

13. The base station of claim 12,
wherein, the message comprises information on a master cell group, and
wherein, in case that the information on a master cell group comprises the information on the reconfiguration with sync, the information on the conditional reconfiguration comprises configurations associated with a subsequent conditional primary secondary cell (PSCell) addition or change (CPAC).

14. The base station of claim 12, wherein the information on the sk-counter configuration comprises the list of sk-counter.

15. The base station of claim 12, wherein the message comprises a radio resource control (RRC) reconfiguration message.
